(19) United States
(12) Patent Application Publication
(10) Pub. No.: US 2014/0324539 A1
(43) Pub. Date: Oct. 30, 2014

(54) METHOD AND SYSTEM FOR MINING TOPIC CORE CIRCLE IN SOCIAL NETWORK

(71) Applicant: Huawei Technologies Co., Ltd., Shenzhen (CN)

(72) Inventors: Zhirong Liu, Shenzhen (CN); Liangwei Wang, Shenzhen (CN)

(21) Appl. No.: 14/328,203

(22) Filed: Jul. 10, 2014

Related U.S. Application Data
(63) Continuation of application No. PCT/CN2013/070549, filed on Jan. 16, 2013.

(30) Foreign Application Priority Data
Jun. 25, 2012 (CN) 201210210349.9

(51) Int. Cl. G06Q 30/02; G06Q 50/00

(52) U.S. Cl. CPC G06Q 30/0202; G06Q 50/01
USPC 705/7.31

(57) ABSTRACT

Embodiments of the present invention apply to the field of social networks, and provide a method and a system for mining a topic core circle in a social network, where the method includes: creating a social network diagram; selecting a node from the social network diagram as a first node of a core circle, adding a second node that has most connections with the first node to the core circle, adding a third node to the core circle, and performing similar operations until an N^{th} node outside the core circle is added to the core circle, where the N is a preset number of nodes included in the core circle; and performing topic clustering for the core circle including N nodes. By adopting the embodiments of the present invention, core circles with a similar topic and a close relationship in the social network can be effectively mined.

### CROSS-REFERENCE TO RELATED APPLICATIONS

This application is a continuation of International Application No. PCT/CN2013/070549, filed on Jan. 16, 2013, which claims priority to Chinese Patent Application No. 201210210349.9, filed on Jun. 25, 2012, both of which are hereby incorporated by reference in their entireties.

### TECHNICAL FIELD

The present invention relates to the field of social network technologies, and in particular, to a method and a system for mining a topic core circle in a social network.

### BACKGROUND

Currently, information on the Internet is growing in size, and is complex. How to analyze content of the Internet to mine what people are desirous of? A social network mining technology can solve this problem to some extent.

The prior art provides a community mining method based on a community structure, and specific steps of the method are as follows:

1) Delimit a search area in a social network according to a scale and a scope of a community to be mined, where a left boundary L of the search area is a size of the largest community that is currently expected to be mined, an upper boundary U is the number of neighboring nodes of a node having most neighbors in the social network, a right boundary is U/β+1, and a lower boundary is β(L−1), where β represents a preset proportion;

2) Perform a pruning operation in the search area according to the number of neighboring nodes of a node, and prune away the node, with the number of neighboring nodes less than degree of closeness of the community to be mined, from the social network;

3) Select a node from remaining nodes of the social network after the pruning operation, search the neighboring nodes of the node for a community with a size of |S|−1, form, after the community is found, a community to be mined by using the node and the found community with the size of |S|−1, and add the community to a result set, where the |S| represents the size of the community expected to be mined; and

4) Move left the left boundary of the search area, and then perform step 2) and step 3) again in an expanded search area until the search area reaches a minimum value of the scale of the community to be mined.

In the prior art, although the content that people need can be mined to some extent, core circles with a similar topic, a close relationship, and a great influence cannot be mined in the prior art.

### SUMMARY

An embodiment of the present invention provides a method for mining a topic core circle in a social network, so as to mine a core circle with a similar topic and a close relationship in the social network.

In implementation of the embodiment of the present invention, the method for mining a topic core circle in a social network includes:

creating a social network diagram, where the social network diagram includes multiple interconnected nodes;

selecting a node from the social network diagram as a first node of a core circle, adding a second node that has most connections with the first node to the core circle, adding a third node, which is outside the core circle and has most connections with nodes inside the core circle, to the core circle, and performing similar operations until an N^{th} node outside the core circle is added to the core circle, where the N is a preset number of nodes included in the core circle; and

performing topic clustering for the core circle including N nodes, and acquiring a topic of concern of each node inside the core circle including N nodes.

An embodiment of the present invention further provides a system for mining a topic core circle in a social network, where the system includes:

a creating unit, configured to create a social network diagram, where the social network diagram includes multiple interconnected nodes;

a core circle acquiring unit, configured to select a node from the social network diagram created by the creating unit as a first node of a core circle, add a second node that has most connections with the first node to the core circle, add a third node, which is outside the core circle and has most connections with nodes inside the core circle, to the core circle, and perform similar operations until an N^{th} node outside the core circle is added to the core circle, where the N is a preset number of nodes included in the core circle; and

a topic acquiring unit, configured to perform topic clustering for the core circle that is acquired by the core circle acquiring unit and contains N nodes, and acquire a topic of concern of each node inside the core circle including N nodes. In the embodiments of the present invention, a node that is outside the core circle in the social network diagram and has most connections with nodes inside the core circle is added to the core circle. Because there are many connection relationships among nodes (users), it indicates that relationships among the users are close, and topics are most likely similar. Acquiring the topic of concern of each node inside the core circle by performing topic clustering for the acquired core circle takes topics of the social network into account. According to the core circle and the topic of concern, a user can search for core circles with a similar topic and a close relationship by using a keyword.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show some embodiments of the present invention, and a person of ordinary skill in the art may still derive other drawings from these accompanying drawings without creative efforts.

FIG. 1 is an implementation flowchart of a method for mining a topic core circle in a social network according to an embodiment of the present invention;

FIG. 2 is an implementation flowchart of a method for mining a topic core circle in a social network according to another embodiment of the present invention;

FIG. 3 is an implementation flowchart of a method for mining a topic core circle in a social network according to still another embodiment of the present invention;

FIG. 4 is an example diagram of a relationship between a core circle and an assisted community according to another embodiment of the present invention; and

FIG. 5 is a composite structure diagram of a system for mining a topic core circle in a social network according to another embodiment of the present invention.

### DETAILED DESCRIPTION

To make the objectives, technical solutions, and advantages of the present invention more comprehensible, the following further describes the present invention in detail with reference to the accompanying drawings and embodiments. It should be understood that, the specific embodiments described herein are used for describing the present invention, but are not intended to limit the present invention.

In order to describe the technical solutions of the present invention, specific embodiments are used to make description.

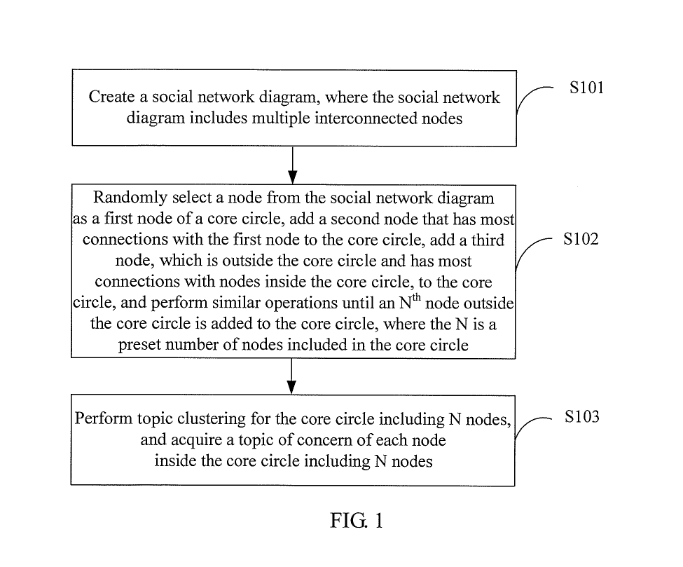

FIG. 1 shows an implementation flow of a method for mining a topic core circle in a social network according to an embodiment of the present invention, and a process of the method is described in detail as follows:

In step S101, create a social network diagram, where the social network diagram contains multiple interconnected nodes.

Preferably, the social network diagram is created according to a cooperation relationship or a concern relationship among users. For example, for an academic paper cooperation relationship network, articles that are in different computer research fields and are published in past two years are collected firstly, where the research fields include: artificial intelligence (AI), database (DB), distributed and parallel calculating (DP), graphics, vision, and human-computer interaction (GV), and network communications and performance analysis (NC). Then, authors of the articles are extracted. A social network diagram is created according to a cooperation relationship among users, where each author is taken as a node in the social network diagram and every two different authors who co-write one or more articles are taken as a boundary in the social network diagram, thereby forming the social network diagram including multiple interconnected nodes.

In step S102, randomly select one node from the social network diagram as a first node of a core circle, add a second node that has most connections with to the core circle, add a third node, which is outside the core circle and has most connections with nodes inside the core circle to the core circle, and perform similar operations until an N^{th} node outside the core circle is added to the core circle, where the N is a preset number of nodes included in the core circle.

In this embodiment, the core circle is established and a size of the core circle (that is, the number of nodes included in the core circle) is set. The core circle is initialized to be empty, one node is selected randomly as a first node inside the core circle, a second node that has most connections with the first node is looked up, the found second node is also added to the core circle, a third node that has most connections with nodes (that is, the first node and the second node) inside the core circle is added to the core circle sequentially, and similar operations is performed until an N^{th} node outside the core circle is added to the core circle. At this time, the number of nodes inside the core circle reaches a preset threshold value N, and node adding stops. Because there are many connection relationships among nodes (users), it indicates that relationships among the users are close, and topics are most likely similar. Therefore, by adopting this embodiment, a core circle with a close relationship and a similar topic can be acquired.

It should be noted that, if there are multiple n^{th} nodes which have most connections with the nodes inside the core circle, one of the n^{th} nodes is selected randomly to add to the core circle, where the n=1, 2, . . . , N.

Preferably, in order to acquire a core circle with a close relationship, a similar topic, and a great influence, after the N^{th} node is added to the core circle, this embodiment further includes:

B1. Calculate a weight sum of all boundaries of each node inside and outside the core circle including N nodes, add a node with the greatest weight sum outside the core circle to the core circle, and remove a node with the smallest weight sum inside the core circle from the core circle; and

B2. Repeat step B1 until the number of repetitions reaches a preset value (for example, five times) or a weight sum of boundaries of each node outside the core circle is less than or equal to the weight sum of boundaries of a node with the smallest weight sum inside the core circle.

It should be noted that, weights of boundaries in this embodiment may be set to be the same or different. For example, for an academic paper cooperation relationship network, weights may be set according to a periodical where the articles are published, and weights of boundaries of co-authors whose articles are published on a core periodical are set to be relatively high.

As shown in Table 1, Table 1 is core circles acquired for the academic paper cooperation relationship network in this embodiment.

TABLE 1

| | |
|---|---|
| AI | Joseph P. Zurkus, Friedrich T. Sommer, William |
| | E. Faller, M. V. Donskoy, V. L. Arlazarov, Robert |
| | B. Pinter, Yuan-sheng Huang, T. Florian Jaeger, |
| | Günther Palm, G. M. Adelson-Velskiy |
| DB | Herbert Stoyan, Gerd Kachel, Silvia Kolmschlag, |
| | Maureen E. McLaughlin, Kathryn Bates Hill, |
| | Cláudia Maria Lima Werner, Alexandre L. Correa, |
| | Douglas D. Brown, Mark A. Rogers, Slawek Staworko |
| DP | Luigi Paura, Xia Fan, Athanasios D. |
| | Panagopoulos, Lian-Lian Gao, Olga Sokolova, |
| | Anastasia Yurgenson, Philip Constantinou, Aden |
| | Grue, Chih-Hsun Chou, Khaleel Ur Rahman Khan |
| GV | Cédric Demonceaux, Jean-Jacques Lemaire, Markus |
| | Glaser, Jan Ehrhardt, Hans J. Wolters, Marc |
| | Sigelle, Ammar Chkeif, Ângela Vilhena Dias, |
| | Jean-Pierre Véran, Jérôme Coste |
| NC | Bruce H. Van Aartser, Cyriel Minkenberg, W. Haelg, |
| | Shujia Zhou, Margaret L. Simmons, Ingrid |
| | Y. Bucher, Szabolcs Pota, Amr M. M. Ashmawy, |
| | Gilbert C. Sih, Stephen B. Weston |

It can be seen from Table 1 that the acquired five core circles in Table 1 are social circles composed of representative figures who are highly active in corresponding fields (a frequency of name occurrence is greater than a preset value) and/or have a great influence (such as professors, academicians, and well-known entrepreneurs) and have close relationships with each another.

In step S103, perform topic clustering for the core circle including N nodes, and acquire a topic of concern of each node inside the core circle including N nodes.

Specifically, a PLSA or LDA clustering algorithm may be used to perform topic clustering for the core circle including N nodes, so as to acquire the topic of concern of each node inside the core circle including N nodes. For example, the PLSA or LDA clustering algorithm is used to perform topic clustering for articles published by each member, so as to acquire a topic of concern of each member.

For another example, regarding the core circles in Table 1, articles published by each member inside the core circles are acquired, content of the articles is pre-processed, including removing stop words and high-frequency words (such as “of”, “for”, or “is”). Words emerged in the pre-processed articles are acquired, a mapping table between the words and the members (IDs) is established, statistics is collected on emergence times of the words in the articles published by each member, and top N words with most emergence times are extracted. The topic of concern of each member is obtained through analysis and summary. For example, top three words with most emergence times in articles of a certain member are “study”, “algorithm”, and “model”, and it is determined that the topic of concern of the member is “artificial intelligence”.

It should be noted that there may be more than one topic of concern for each node inside the core circle, and each node may be in multiple core circles at a same time.

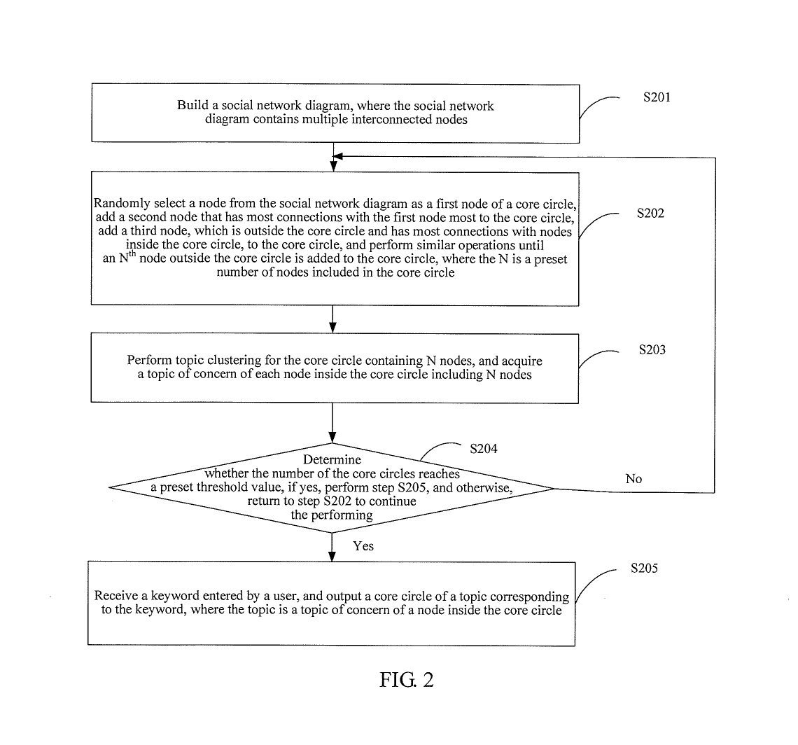

FIG. 2 shows an implementation flow of a method for mining a topic core circle in a social network according to another embodiment of the present invention, and a process of the method is described in detail as follows:

In step S201, create a social network diagram, where the social network diagram contains multiple interconnected nodes.

In step S202, randomly select one node from the social network diagram as a first node of a core circle, add a second node that has most connections with the first node to the core circle, add a third node, which is outside the core circle and has most connections with nodes inside the core circle, to the core circle, and perform similar operations until an N^{th} node outside the core circle is added to the core circle, where the N is a preset number of nodes included in the core circle.

In step S203, perform topic clustering for the core circle including N nodes, and acquire a topic of concern of each node inside the core circle including N nodes.

In this embodiment, steps S201-S203 are the same as steps S101-S103 in the embodiment corresponding to FIG. 1, and for a specific implementation process, reference may be made to relevant descriptions in steps S101-S103 in the embodiment corresponding to FIG. 1, and details are not described herein again.

In step S204, determine whether the number of the core circles reaches a preset threshold value, if yes, perform step S205, and otherwise, return to step S202 to continue the performing.

In this embodiment, the number of the core circles is preset, when the number of core circles obtained by division reaches the preset threshold value, the division stops, and otherwise, return to step S202 to continue the division.

In this embodiment, each node in each divided core circle has a corresponding topic of concern.

In step S205, receive a keyword input by a user, and output a core circle of a topic corresponding to the keyword, where the topic is a topic of concern of a node inside the core circle.

In this embodiment, the topic corresponding to the keyword may be acquired according to an existing search algorithm or according to a pre-established mapping between keywords and topics, and a node that concerns the topic is then acquired, and a core circle where the node is located is output. For example, if a user needs to look up a representative figure in the field of “Database”, the user inputs a keyword “database”. A system acquires a topic “database” corresponding to the keyword according to the keyword input by the user, then acquires a node “Herbert Stoyan” that concerns the topic, and outputs a core circle where the node “Herbert Stoyan” is located, namely, the core circle corresponding to DB in Table 1. Since all other members inside the core circle corresponding to the DB are members that have a close relationship with “Herbert Stoyan”, a group of core circles with a topic similar to “Database”, a close relationship, and a great influence can be found by using “Herbert Stoyan”.

By adopting the embodiment of the present invention, a core circle with a similar topic, a close relationship, and a great influence in the social network can be effectively mined.

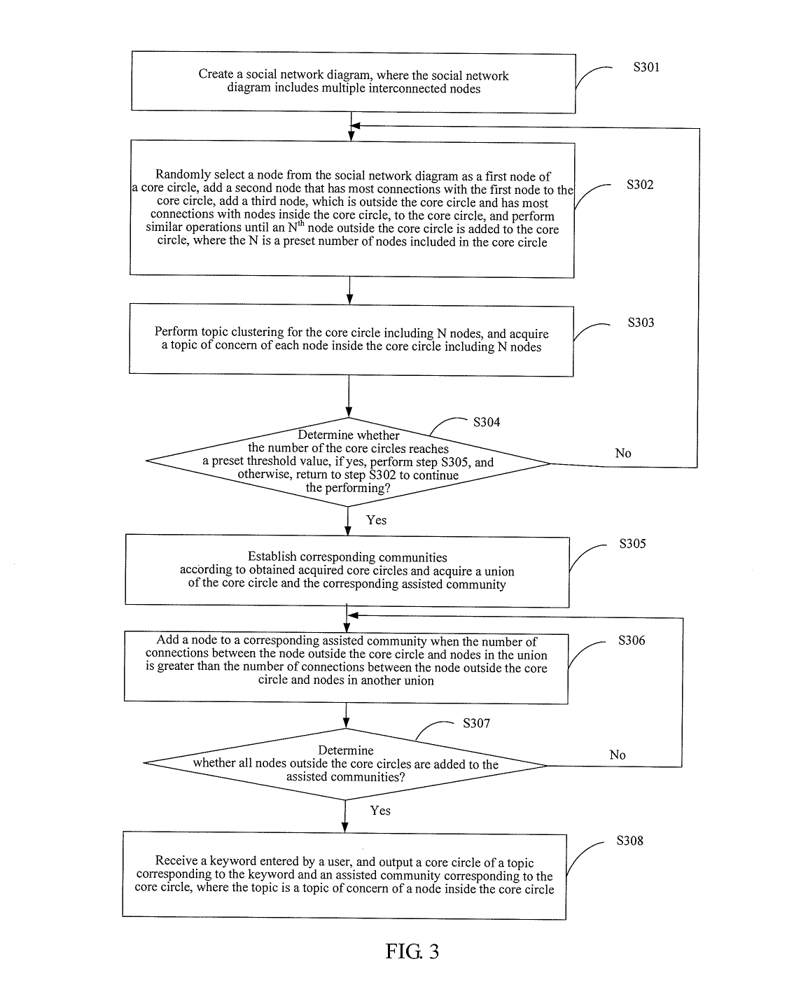

FIG. 3 shows an implementation flow of a method for mining a topic core circle in a social network according to still another embodiment of the present invention, and a process of the method is described in detail as follows:

In step S301, create a social network diagram, where the social network diagram contains multiple interconnected nodes.

In step S302, randomly select one node from the social network diagram as a first node of a core circle, add a second node that has most connections with the first node to the core circle, add a third node, which is outside the core circle and has most connections with nodes inside the core circle, to the core circle, and perform similar operations until an N^{th} node outside the core circle is added to the core circle, where the N is a preset number of nodes included in the core circle.

In step S303, perform topic clustering for the core circle including N nodes, and acquire a topic of concern of each node inside the core circle including N nodes.

In step S304, determine whether the number of the core circles reaches a preset threshold value, if yes, perform step S305, and otherwise, return to step S302 to continue the performing.

In this embodiment, steps S301-S304 are the same as steps S201-S204 in the embodiment corresponding to FIG. 2, and for a specific implementation process, refer to relevant descriptions for steps S201-S204 in the embodiment corresponding to FIG. 2, and details are not described herein again.

In step S305, establish corresponding communities A₁, A₂, . . . , Aₙ according to acquired core circles K₁, K₂, . . . , Kₙ, and let Rᵢ=Kᵢ ∪ Aᵢ, where i=1, 2, . . . , n, and n is the number of the core circles.

In this embodiment, each core circle corresponds to one assisted community. For example, K₁ corresponds to A₁. The assisted community is a group of people interested in a topics inside the core circle, such as a “fan club”.

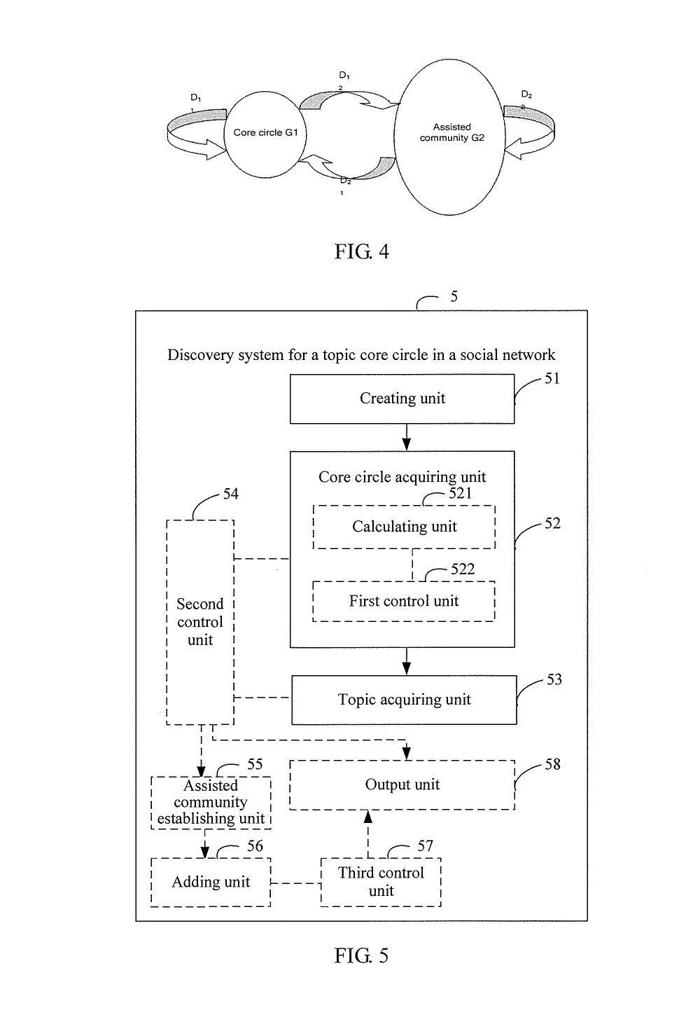

A relationship between a core circle and an assisted community is shown in FIG. 4, where D₁₁ represents relationships among nodes inside a core circle G1, D₁₂ represents relationships between the nodes inside the core circle G1 and nodes inside an assisted community G2, D₂₂ represents relationships among the nodes inside the assisted community G2, D₂₁ represents relationships between the nodes inside the assisted community G2 and the nodes inside the core circle G1, and relationship closeness among D₁₁, D₁₂, D₂₂, D₂₁ is D₂₁>D₁₁>D₂₂>D₁₂.

In step S306, when the number of connections between a node outside the core circles and nodes in Rᵢ is greater than the number of connections between the node outside the core circles and nodes in another Rⱼ, add the node to Aᵢ, where i=1, 2, . . . , n, and j=1, 2, i−1, i+1, . . . , n.

In step S307, determine whether all nodes outside the core circles are added to the assisted communities, if yes, perform step S308, and otherwise, return to step S306 to continue the performing.

In step S308, receive a keyword input by a user, and output a core circle of a topic corresponding to the keyword and an assisted community corresponding to the core circle, where the topic is a topic of concern of a node inside the core circle.

In the embodiment of the present invention, a corresponding assisted community, namely, a group of people interested in topics inside the core circle, can be acquired according to the core circle. Most users outside the core circle are divided by analyzing a small number of core circle users, more user groups with same interests and hobbies are mined, and efficiency of social network division is improved.

FIG. 5 shows a composite structure of a system for mining a topic core circle in a social network according to another embodiment of the present invention. For ease of description, only parts related to the embodiment of the present invention are shown.

The system for mining a topic core circle in a social network may be a software unit, a hardware unit, or a unit combining software and hardware that are operated inside a terminal device (for example, a mobile phone, or an IPAD).

The system 5 for mining a topic core circle in a social network includes a creating unit 51, a core circle acquiring unit 52, and a topic acquiring unit 53, and specific functions thereof are as follows.

The creating unit 51 is configured to create a social network diagram, where the social network diagram contains multiple interconnected nodes. Preferably, the creating unit 51 is configured to create the social network diagram according to a cooperation relationship or a concern relationship among users.

The core circle acquiring unit 52 is configured to randomly select one node from the social network diagram created by the creating unit 51 as a first node of a core circle, add a second node that has most connections with the first node most to the core circle, add a third node, which is outside the core circle and has most connections with nodes inside the core circle, to the core circle, and perform similar operations until an N^{th} node outside the core circle is added to the core circle, where the N is a preset number of nodes included in the core circle.

The topic acquiring unit 53 is configured to perform topic clustering for the core circle that is acquired by the core circle acquiring unit 52 and contains N nodes, and acquire a topic of concern of each node inside the core circle including N nodes.

Further, the core circle acquiring unit 52 further includes:

a calculating unit 521, configured to calculate weight sums of all boundaries of nodes inside and outside the core circle including N nodes, add a node with the greatest weight sum outside the core circle to the core circle, and remove a node with the smallest weight sum inside the core circle from the core circle; and

a first control unit 522, configured to, when computation times of the calculating unit 521 reach a preset value or weight sums of boundaries of nodes outside the core circle are less than or equal to weight sums of boundaries of nodes inside the core circle, stop computation of the calculating unit 521.

Further, the system 5 further includes:

a second control unit 54, configured to determine whether the number of core circles in the social network diagram reaches a preset threshold value, if yes, stop acquiring the core circle, and otherwise, continue the acquiring until the number of the core circles reaches the preset threshold value, where each node inside each core circle has a corresponding topic of concern.

Further, the system 5 further includes:

an assisted community establishing unit 55, configured to establish corresponding communities A₁, A₂, . . . , Aₙ according to acquired core circles K₁, K₂, . . . , Kₙ, and let Rᵢ=Kᵢ ∪ Aᵢ, where i=1, 2, . . . , n, and n is the number of the core circles;

an adding unit 56, configured to, when the number of connections between a node outside the core circles and nodes in Rᵢ is greater than the number of connections between the node outside the core circles and nodes in another Rⱼ, add the node to Aᵢ, where i=1, 2, . . . , n, and j=1, 2, i−1, i+1, . . . , n; and

a third control unit 57, configured to, when all nodes outside the core circles are added to the assisted communities, stop the adding unit 56 from adding a node.

Further, the system further includes:

an output unit 58, configured to receive a keyword input by a user, and output a core circle of a topic corresponding to the keyword and/or an assisted community corresponding to the core circle, where the topic is a topic of concern of a node inside the core circle.

Further, the creating unit 51 is specifically configured to create the social network diagram according to a cooperation relationship or a concern relationship among users.

The system for mining a topic core circle in a social network provided by this embodiment may use the foregoing corresponding method for mining a topic core circle in a social network. For details, refer to relevant descriptions in the embodiments corresponding to FIG. 1, FIG. 2, and FIG. 3 for the method for mining a topic core circle in a social network, which are not described herein again.

A person of ordinary skill in the art can understand that units included in the embodiment corresponding to FIG. 5 are divided only according to function logic. However, the division is not limited thereto so long as corresponding functions can be implemented. In addition, the specific name of each functional unit is only for convenience of differentiation and is not intended to limit the protection scope of the present invention.

In conclusion, in the embodiments of the present invention, by using acquired core circle and topic of concern of each node inside a core circle, a user can easily mine a core circle with a similar topic, a close relationship, and a great influence in the social network. In addition, the corresponding assisted community, namely, a group of people interested in topics inside the core circle, can be acquired according to the acquired core circle. Most users outside the core circle are divided by analyzing a small number of core circle users, more user groups with a same interest and hobby are mined, and efficiency of social network division is improved.

A person of ordinary skill in the art may also understand that all or a part of the steps of the methods in the embodiments may be implemented by a program instructing relevant hardware. The program may be stored in a computer readable storage medium. The storage medium includes: a ROM/RAM, a magnetic disk, or an optical disc.

The foregoing descriptions are merely exemplary embodiments of the present invention, but are not intended to limit the present invention. Any modification, equivalent replacement, or improvement made without departing from the spirit and principle of the present invention should fall within the protection scope of the present invention.

What is claimed is:

1. A method for mining a topic core circle in a social network, the method comprising:
creating a social network diagram, wherein the social network diagram comprises multiple interconnected nodes;
selecting a node from the social network diagram as a first node of a core circle, adding a second node that has most connections with the first node to the core circle, adding a third node, which is outside the core circle and has most connections with nodes inside the core circle, to the core circle, and performing similar operations until an N^{th} node outside the core circle is added to the core circle, wherein the N is a preset number of nodes comprised in the core circle; and
performing topic clustering for the core circle comprising N nodes, and acquiring a topic of concern of each node inside the core circle comprising N nodes.

2. The method according to claim 1, wherein selecting a node from the social network diagram as a first node of a core circle, adding a second node that has most connections with the first node to the core circle, adding a third node, which is outside the core circle and has most connections with nodes inside the core circle, to the core circle, and performing similar operations until an N^{th} node outside the core circle is added to the core circle, wherein the N is a preset number of nodes comprised in the core circle further comprises:
calculating weight sums of all boundaries of nodes inside and outside the core circle comprising N nodes, adding a node with the greatest weight sum outside the core circle to the core circle, removing a node with the smallest weight sum inside the core circle from the core circle, and performing similar operations until the number of computation times reaches a preset value or a weight sum of boundaries of each node outside the core circle is smaller than or equal to a weight sums of boundaries of the node with the smallest weight sum inside the core circle.

3. The method according to claim 1, after performing topic clustering for the core circle comprising N nodes, and acquiring a topic of concern of each node inside the core circle comprising N nodes, the method further comprises:
determining whether the number of core circles in the social network diagram reaches a preset threshold value; and if yes, stopping acquiring the core circle, and otherwise, continuing the acquiring until the number of the core circles reaches the preset threshold value, wherein each node inside each core circle has a corresponding topic of concern.

4. The method according to claim 1, wherein the method further comprises:
establishing corresponding assisted communities A₁, A₂, . . . , Aₙ according to the acquired core circles K₁, K₂, . . . , Kₙ to make Rᵢ=Kᵢ ∪ Aᵢ, wherein i=1, 2, . . . , n, and n is the number of the core circles; and
when the number of connections between a node outside the core circles and nodes in Rᵢ is greater than the number of connections between the node and nodes in another Rⱼ, adding the node to Aᵢ, wherein i=1, 2, . . . , n and j=1, 2, i−1, i+1, . . . , n, and performing similar operations until all nodes outside the core circles are added to the assisted communities.

5. The method according to claim 1, wherein the method further comprises:
receiving a keyword entered by a user, and outputting a core circle of a topic corresponding to the keyword and/or an assisted community corresponding to the core circle, wherein the topic is a topic of concern of a node inside the core circle.

6. The method according to claim 1, wherein creating a social network diagram comprises:
creating the social network diagram according to a cooperation relationship or a concern relationship among users.

7. A system for mining a topic core circle in a social network, the system comprising:
a creating unit, configured to create a social network diagram, wherein the social network diagram comprises multiple interconnected nodes;
a core circle acquiring unit, configured to select a node from the social network diagram created by the creating unit as a first node of a core circle, add a second node that has most connections with the first node to the core circle, add a third node, which is outside the core circle and has most connections with nodes inside the core circle, to the core circle, and perform similar operations until an N^{th} node outside the core circle is added to the core circle, wherein the N is a preset number of nodes comprised in the core circle; and
a topic acquiring unit, configured to: perform topic clustering for the core circle that is acquired by the core circle acquiring unit and comprises N nodes, and acquire a topic of concern of each node inside the core circle comprising N nodes.

8. The system according to claim 7, wherein the core circle acquiring unit further comprises:
a calculating unit, configured to calculate weight sums of all boundaries of nodes inside and outside the core circle comprising N nodes, add a node with the greatest weight sum outside the core circle to the core circle, and remove a node with the smallest weight sum inside the core circle from the core circle; and
a first control unit, configured to, when the number of computation times of the calculating unit reaches a preset value or a weight sum of boundaries of each node outside the core circle is smaller than or equal to a weight sum of boundaries of the node with the smallest sum inside the core circle, stop calculation of the calculating unit.

9. The system according to claim 7, wherein the system further comprises:
a second control unit, configured to: determine whether the number of core circles in the social network diagram reaches a preset threshold value; and if yes, stop acquiring the core circle, and otherwise, continue the acquiring until the number of the core circles reaches the preset threshold value, wherein each node inside each core circle has a corresponding topic of concern.

10. The system according to claim 7, wherein the system further comprises:
an assisted community establishing unit, configured to establish corresponding communities A₁, A₂, . . . , Aₙ according to the acquired core circles K₁, K₂, . . . , Kₙ, and let Rᵢ=Kᵢ ∪ Aᵢ, wherein i=1, 2, . . . , n, and n is the number of the core circles; and
an adding unit, configured to: when the number of connections between a node outside the core circles and nodes in Rᵢ is greater than the number of connections between the node outside the core circles and nodes in another Rⱼ, add the node to Aᵢ, wherein i=1, 2, . . . , n and j=1, 2, i−1, i+1, . . . , n; and
a third control unit, configured to: when all nodes outside the core circles are added to the assisted communities, stop the adding unit from adding a node.

11. The system according to claim 7, wherein the system further comprises:
an output unit, configured to receive a keyword entered by a user, and output a core circle of a topic corresponding to the keyword and/or an assisted community corresponding to the core circle, wherein the topic is a topic of concern of a node inside the core circle.

12. The system according to claim 7, wherein the creating unit is configured to create the social network diagram according to a cooperation relationship or a concern relationship among users.
